(19) United States
(12) Patent Application Publication
(10) Pub. No.: US 2022/0140491 A1
(43) Pub. Date: May 5, 2022

(54) RECONFIGURABLE ANTENNA AND METHOD FOR MANUFACTURING THE SAME

(71) Applicant: BOE TECHNOLOGY GROUP CO., LTD., Beijing (CN)

(72) Inventors: Yali WANG, Beijing (CN); Xiaoyan ZHU, Beijing (CN); Dongdong ZHANG, Beijing (CN); Feng QU, Beijing (CN)

(21) Appl. No.: 17/385,036

(22) Filed: Jul. 26, 2021

(30) Foreign Application Priority Data
Oct. 30, 2020 (CN) 202011189376.3

(51) Int. Cl. H01Q 15/00; H01Q 3/44; G02F 1/1333

(52) U.S. Cl. CPC H01Q 15/0066; G02F 1/1333; H01Q 3/44

(57) ABSTRACT

A reconfigurable antenna and a method for manufacturing the same are provided. The reconfigurable antenna includes: a first substrate and a second substrate opposite to each other, a liquid crystal layer between the first substrate and the second substrate, a first metal layer between the first substrate and the liquid crystal layer, and a second metal layer between the second substrate and the liquid crystal layer. The first metal layer serves as a radiation patch layer of the reconfigurable antenna. The second metal layer serves as a ground layer of the reconfigurable antenna. The first metal layer and the second metal layer are configured to provide an electric field to the liquid crystal layer, so as to rotate orientation vectors of liquid crystal molecules of the liquid crystal layer.

### CROSS REFERENCE TO RELATED APPLICATIONS

The present application claims priority to Chinese patent application No. 202011189376.3, filed on Oct. 30, 2020, the content of which is incorporated herein by reference in its entirety.

### TECHNICAL FIELD

The present disclosure relates to the field of antenna technology, and in particular, to a reconfigurable antenna and a method for manufacturing a reconfigurable antenna.

### BACKGROUND

A reconfigurable antenna is an antenna that has a plurality of changeable characteristics (or a plurality of reconfigurable parameters) by a certain adjustment, and the plurality of reconfigurable parameters mainly include a resonant frequency of the reconfigurable antenna, a directional pattern of the reconfigurable antenna, a polarization of the reconfigurable antenna, and a combination of the three. The reconfigurable antenna has the advantages of simplifying a complex system, reducing the cost thereof, and reducing the number of the antennas, and thus is advantageous for integration.

### SUMMARY

A first aspect of the present disclosure provides a reconfigurable antenna, which includes:
a first substrate and a second substrate opposite to each other;
a liquid crystal layer between the first substrate and the second substrate;
a first metal layer between the first substrate and the liquid crystal layer, wherein the first metal layer serves as a radiation patch layer of the reconfigurable antenna; and
a second metal layer between the second substrate and the liquid crystal layer, wherein the second metal layer serves as a ground layer of the reconfigurable antenna;
wherein the first metal layer and the second metal layer are configured to provide an electric field to the liquid crystal layer, so as to rotate orientation vectors of liquid crystal molecules of the liquid crystal layer.

In an embodiment, the reconfigurable antenna further includes a support structure, wherein the support structure is between the first substrate and the second substrate, an orthogonal projection of the liquid crystal layer on the first substrate and an orthogonal projection of the first metal layer on the first substrate are both within an area defined by an orthogonal projection of the support structure on the first substrate.

In an embodiment, the orthogonal projection of the support structure on the first substrate defines a plurality of areas, which are not in communication with each other.

In an embodiment, the orthogonal projection of the support structure on the first substrate defines a plurality of areas, at least adjacent two of which are in communication with each other.

In an embodiment, the reconfigurable antenna further includes a microstrip transmission line, wherein one end of the microstrip transmission line is connected to the first metal layer.

In an embodiment, the reconfigurable antenna further includes a first barrier layer and a second barrier layer, wherein the first barrier layer is between the first substrate and the first metal layer, and the second barrier layer is between the second substrate and the second metal layer.

In an embodiment, each of the first substrate and the second substrate is a flexible substrate.

In an embodiment, each of the first substrate and the second substrate has a thickness of 90 μm to 110 μm, 45 μm to 55 μm, or 18 μm to 22 μm, a dielectric constant of 4.25 to 5.19, and a tangent of a dielectric loss angle of 0.0042 to 0.0052.

In an embodiment, a thickness of each of the first metal layer and the second metal layer is 1.26 μm to 1.54 μm, 0.9 μm to 1.1 μm, 1.08 μm to 1.32 μm, or 7.2 μm to 8.8 μm.

In an embodiment, the liquid crystal layer is has a thickness of 90 μm to 110 μm or 180 μm to 220 μm;
the liquid crystal layer has a vertical-state dielectric constant of 2.3 to 2.5, and a tangent of a vertical-state dielectric loss angle of 0.01 to 0.1; and
the liquid crystal layer has a horizontal-state dielectric constant of 2.9 to 3.1, and a tangent of a horizontal-state dielectric loss angle of 0.001 to 0.1.

In an embodiment, the radiation patch layer has a shape of a rectangle, a length of 23 mm to 28.2 mm, and a width of 14 mm to 18 mm; and

the microstrip transmission line has a linewidth of 0.39 mm to 0.46 mm or 0.43 mm to 0.53 mm.

In an embodiment, each of the first substrate and the second substrate includes a flexible organic material, which includes polyimide, polycarbonate, polyacrylate, polyetherimide, polyethersulfone, polyethylene terephthalate, or polyethylene naphthalate.

In an embodiment, the plurality of areas have a same shape of a rectangle, and are arranged in a preset direction.

In an embodiment, the plurality of areas have a same shape of a rectangle, and are arranged in an array including a plurality of rows and a plurality of columns.

In an embodiment, each of the first barrier layer and the second barrier layer includes an inorganic material.

In an embodiment, each of the first barrier layer and the second barrier layer includes a single layer of SiO₂, or a double layer including a single layer of SiO₂and a single layer of a-Si.

In an embodiment, the single layer of SiO₂ has a thickness between 2,000 Å and 6,000 Å, and the single layer of a-Si has a thickness of 15 Å.

A second aspect of the present disclosure provides a method for manufacturing a reconfigurable antenna, including:
forming a first metal layer on a first substrate;
forming a second metal layer on a second substrate;
aligning the first substrate on which the first metal layer is formed and the second substrate on which the second metal layer is formed with each other and assembling the first substrate and the second substrate into a cell, and forming a liquid crystal layer between the first substrate and the second substrate;
wherein the first metal layer is located between the first substrate and the liquid crystal layer, the second metal layer is located between the second substrate and the liquid crystal layer, the first metal layer serves as a radiation patch layer of the reconfigurable antenna, and the second metal layer serves as a ground layer of the reconfigurable antenna.

In an embodiment, the method further includes, prior to the aligning the first substrate on which the first metal layer is formed and the second substrate on which the second metal layer is formed with each other and assembling the first substrate and the second substrate into a cell, forming a support structure on the second substrate,
wherein, after the aligning the first substrate on which the first metal layer is formed and the second substrate on which the second metal layer is formed with each other and assembling the first substrate and the second substrate into a cell, an orthogonal projection of the liquid crystal layer on the first substrate and an orthogonal projection of the first metal layer on the first substrate are both located within an area defined by an orthogonal projection of the support structure on the first substrate.

In an embodiment, the method further includes, prior to the aligning the first substrate on which the first metal layer is formed and the second substrate on which the second metal layer is formed with each other and assembling the first substrate and the second substrate into a cell,
forming a first barrier layer on the first substrate, and forming a second barrier layer on the second substrate;
wherein the first metal layer is located on a side of the first barrier layer distal to the first substrate, and the second metal layer is located on a side of the second barrier layer distal to the second substrate.

### BRIEF DESCRIPTION OF THE DRAWINGS

The accompanying drawings, which are provided for further understanding of the present disclosure and constitute a part of this specification, are for explaining the present disclosure together with the following exemplary embodiments, but are not intended to limit the present disclosure. In the drawings:

FIG. 1 is a schematic diagram showing a structure of a reconfigurable antenna according to an embodiment of the present disclosure;

FIG. 2 is a schematic diagram showing a structure of another reconfigurable antenna according to an embodiment of the present disclosure;

FIGS. 3a-3h are schematic plan views showing a support structure, a first metal layer, and a first substrate, i.e., positional relationships between an orthogonal projection of the support structure on the first substrate and an orthogonal projection of the first metal layer on the first substrate, according to some embodiments of the present disclosure;

FIG. 4 is a schematic flowchart of a method for manufacturing a reconfigurable antenna according to an embodiment of the present disclosure;

FIG. 5 is a schematic diagram showing structures of a reconfigurable antenna in steps of a method for manufacturing the reconfigurable antenna, according to an embodiment of the present disclosure; and

FIG. 6 is a schematic diagram showing support structures provided with liquid crystal filling openings, respectively, according to an embodiment of the present disclosure.

### DETAILED DESCRIPTION

Exemplary embodiments of the present disclosure will be described in detail below with reference to the accompanying drawings. It should be understood that the exemplary embodiments described herein are only for illustrating and explaining the present disclosure, and are not intended to limit the present disclosure.

Unless otherwise defined, technical or scientific terms used in an embodiment of the present disclosure should have the ordinary meaning as understood by one of ordinary skill in the art to which the present disclosure belongs. The terms of “first”, “second”, and the like in the present disclosure are not intended to indicate any order, quantity, or importance, but rather are used for distinguishing one element from another. Similarly, the term of “comprising”, “including”, or the like, means that the element or item preceding the term contains the element or item listed after the term and the equivalent thereof, but does not exclude the presence of other elements or items. The terms “connected” or “coupled” and the like are not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

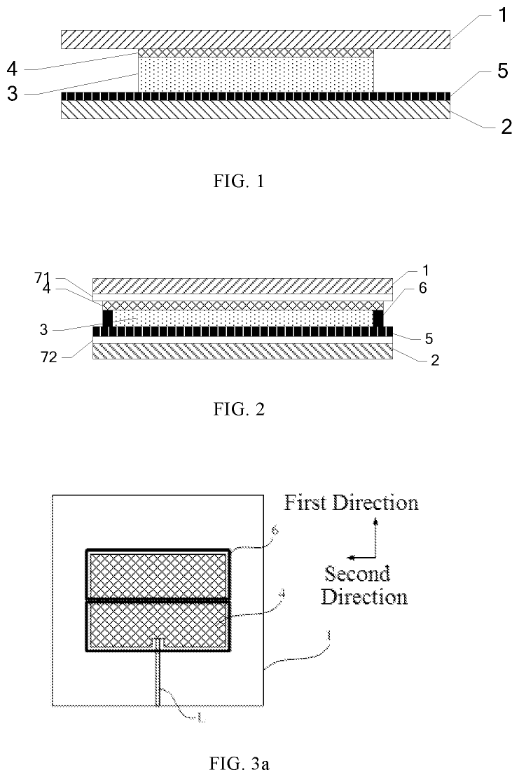

An embodiment of the present disclosure provides a reconfigurable antenna, and FIG. 1 is a schematic diagram showing a structure of the reconfigurable antenna according to the present embodiment. As shown in FIG. 1, the reconfigurable antenna includes: a first substrate 1, a second substrate 2, a liquid crystal layer 3, a first metal layer 4, and a second metal layer 5. The first substrate 1 and the second substrate 2 are disposed opposite to each other, and the liquid crystal layer 3 is disposed between the first substrate 1 and the second substrate 2. The first metal layer 4 is disposed between the first substrate 1 and the liquid crystal layer 3, and the second metal layer 5 is disposed between the second substrate 2 and the liquid crystal layer 3. The first metal layer 4 serves as a radiation patch layer of the reconfigurable antenna, and the second metal layer 5 serves as a ground layer (or grounding layer) of the reconfigurable antenna. The radiation patch layer may transmit or receive a radio frequency signal in response to a signal fed into the reconfigurable antenna. The first metal layer 4 and the second metal layer 5 may provide an electric field to the liquid crystal layer 3 to rotate orientation vectors (which may be referred to as directors) of liquid crystal molecules (e.g., directions in which long axes of liquid crystal molecules extend, respectively) of the liquid crystal layer 3. In other words, different voltages may be applied to the first metal layer 4 and the second metal layer 5, respectively, such that the first metal layer 4 and the second metal layer 5 generate therebetween an electric field that rotates the liquid crystal molecules (or the orientation vectors of the liquid crystal molecules) of the liquid crystal layer 3.

In the present embodiment, the reconfigurable antenna may be a frequency reconfigurable antenna. An orthogonal projection of the first metal layer 4 on the first substrate 1 and an orthogonal projection of the second metal layer 5 on the first substrate 1 at least partially overlap each other, and an overlapping area of the orthogonal projections of the first metal layer 4 and the second metal layer 5 on the first substrate 1 covers an orthogonal projection of the liquid crystal layer 3 on the first substrate 1. As such, when different voltages are applied to the first metal layer 4 and the second metal layer 5, respectively, the first metal layer 4 and the second metal layer 5 may provide an electric field to the liquid crystal layer 3. The orientation vectors of the liquid crystal molecules of the liquid crystal layer 3 are rotated according to the electric field, and the orientation vectors of the liquid crystal molecules of the liquid crystal layer 3 may be continuously rotated in a certain range of angles as the electric field is changed. Since a dielectric constant (i.e., a permittivity) of the liquid crystal layer 3 depends on an angle at which the orientation vectors of the liquid crystal molecules of the liquid crystal layer 3 are rotated, and a resonant frequency of the reconfigurable antenna depends on the dielectric constant of the liquid crystal layer 3. Therefore, the resonant frequency of the reconfigurable antenna can be adjusted by controlling a rotation angle of the orientation vectors of the liquid crystal molecules of the liquid crystal layer 3, and the resonant frequency can be continuously adjusted within a certain range. In this way, the frequency reconfigurable antenna can be realized.

The structure of the reconfigurable antenna according to the present embodiment will be further described below with reference to FIGS. 1-3h. In some embodiments, each of the first substrate 1 and the second substrate 2 is a flexible substrate, such that the reconfigurable antenna has a certain flexibility to facilitate integration with other components. For example, each of the first substrate 1 and the second substrate 2 is made of a flexible organic material such as a resin-based material, which may be polyimide, polycarbonate, polyacrylate, polyetherimide, polyethersulfone, polyethylene terephthalate, polyethylene naphthalate, or the like.

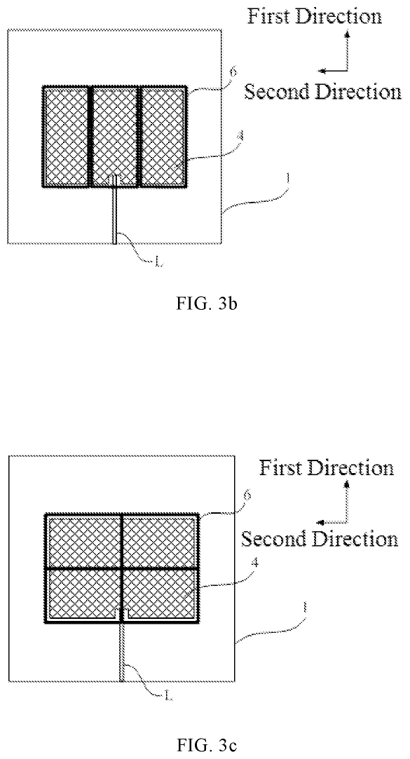

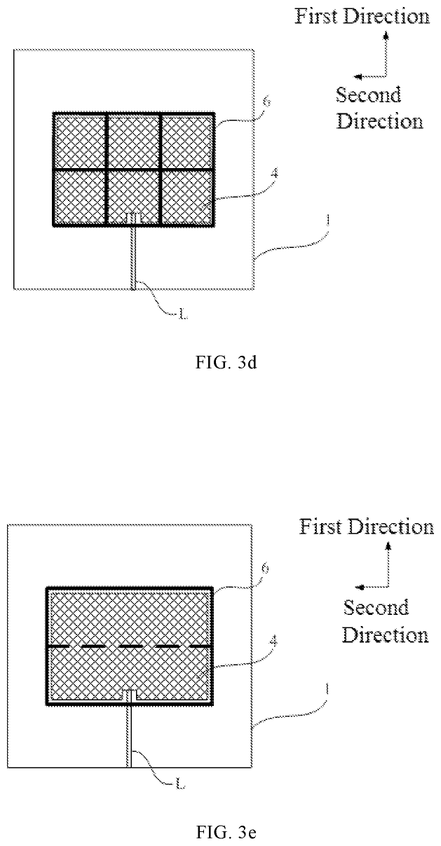

FIG. 2 is a schematic diagram showing a structure of another reconfigurable antenna according to an embodiment of the present disclosure, and FIGS. 3a-3h are schematic plan views of a support structure 6, the first metal layer 4, and the first substrate 1 in some embodiments. It should be noted that the liquid crystal layer 3 is omitted in FIGS. 3a-3h for clarity of illustration. As shown in FIGS. 2-3h, in some embodiments, the reconfigurable antenna further includes the support structure 6, in addition to the first substrate 1, the second substrate 2, the liquid crystal layer 3, the first metal layer 4, and the second metal layer 5 as shown in FIG. 1. The support structure 6 is disposed between the first substrate 1 and the second substrate 2, such that the orthogonal projection of the liquid crystal layer 3 on the first substrate 1 and the orthogonal projection of the first metal layer 4 on the first substrate 1 are both located within an area defined by an orthogonal projection of the support structure 6 on the first substrate 1.

In an embodiment of the present disclosure, as shown in FIG. 2, the first metal layer 4 may be located right below the first substrate 1, and the support structure 6 may be formed by curing a sealant (e.g., an adhesive) for sealing the liquid crystal layer 3 or may be an additional structure formed by curing the sealant. The support structure 6, the first metal layer 4 and the second metal layer 5 together may form a liquid crystal filling region (i.e., a space for accommodating the liquid crystal layer 3), which is used for filling liquid crystal material to form the liquid crystal layer 3 therein. Moreover, the support structure 6 can serve as a supporting component for preventing the first substrate 1 and the second substrate 2, which are made of a flexible material, from deforming to have an influence on the liquid crystal layer 3.

In some embodiments, the orthogonal projection of the support structure 6 on the first substrate 1 defines a plurality of areas, which are not in communication with each other, as shown in FIGS. 3a-3d. As such, a sealing effect on the liquid crystal layer 3 is improved.

In an example, the orthogonal projection of the support structure 6 on the first substrate 1 defines a plurality of rectangular areas (i.e., rectangles) having (or with) a same shape, and the plurality of rectangular areas may be arranged along a preset direction. For example, as shown in FIG. 3a, the orthogonal projection of the support structure 6 on the first substrate 1 defines two rectangular areas. Each of the two rectangular areas may have a length of 14.85 mm to 18.15 mm, for example, of 16.5 mm, and may have a width of 9.9 mm to 12.1 mm, for example of 11 mm. The two rectangular areas may be arranged in a first direction in FIG. 3a (e.g., the first direction may be a direction perpendicular to the plan view shown in FIG. 2). As a further example, as shown in FIG. 3b, the orthogonal projection of the support structure 6 on the first substrate 1 defines three rectangular areas. Each of the three rectangular areas may have a length of 29.7 mm to 36.3 mm, for example, of 33 mm, and may have a width of 6.3 mm to 7.7 mm, for example, of 7 mm. The three rectangular areas may be arranged in a second direction in FIG. 3b (e.g., the second direction may be a horizontal direction in FIG. 2).

In another example, the orthogonal projection of the support structure 6 on the first substrate 1 defines a plurality of rectangular areas having a same shape, and the plurality of rectangular areas are arranged in an array. For example, as shown in FIG. 3c, the orthogonal projection of the support structure 6 on the first substrate 1 defines four rectangular areas, and the four rectangular areas are arranged in an array without being in communication with each other, such that the number of rectangular areas arranged in the second direction may be equal to the number of rectangular areas arranged in the first direction. For another example, as shown in FIG. 3d, the orthogonal projection of the support structure 6 on the first substrate 1 defines six rectangular areas. The six rectangular areas are arranged in an array but are not in communication with each other, and the number of rectangular areas arranged in the second direction may be larger than the number of rectangular areas arranged in the first direction.

In other embodiments, the orthogonal projection of the support structure 6 on the first substrate 1 defines a plurality of areas, and at least adjacent two of the plurality of areas are in communication with each other, as shown in FIGS. 3e-3h. As such, the uniformity of a thickness (e.g., a dimension in a stacking direction of the first substrate 1 and the second substrate 2 (i.e., in the vertical direction) shown in FIG. 1 or 2) of the liquid crystal layer 3 can be improved.

In an example, the orthogonal projection of the support structure 6 on the first substrate 1 defines a plurality of rectangular areas having a same shape. The plurality of rectangular areas may be arranged along a preset direction, and any adjacent two of the plurality of rectangular areas are in communication with each other. For example, as shown in FIG. 3e, the orthogonal projection of the support structure 6 on the first substrate 1 defines two rectangular areas, which may be arranged along the first direction in FIG. 3e, and in communication with each other. For another example, as shown in FIG. 3f, the orthogonal projection of the support structure 6 on the first substrate 1 defines three rectangular areas which may be arranged along the second direction in FIG. 3f, and the rectangular area in the middle is in communication with the rectangular areas at both sides thereof, respectively. In another example, the orthogonal projection of the support structure 6 on the first substrate 1 defines a plurality of rectangular areas having a same shape, and the plurality of rectangular areas are arranged in an array. For example, as shown in FIG. 3g, the orthogonal projection of the support structure 6 on the first substrate 1 defines four rectangular areas. The four rectangular areas are arranged in an array and are in communication with each other, such that the number of rectangular areas arranged in the second direction may be equal to the number of rectangular areas arranged in the first direction. For another example, as shown in FIG. 3h, the orthogonal projection of the support structure 6 on the first substrate 1 defines six rectangular areas, which are arranged in an array and are in communication with each other. Further, the number of rectangular areas arranged in the second direction may be larger than the number of rectangular areas arranged in the first direction.

It should be noted that, in the above examples, the shape of each of the areas defined by the orthogonal projection of the support structure 6 on the first substrate 1 and the directions in which the areas are arranged are only exemplary, but are not intended to limit the scope of the present disclosure. For example, each of the areas defined by the orthogonal projection of the support structure 6 on the first substrate 1 may also be another pattern such as a circle, a hexagon, a triangle, or the like. Further, the arrangement direction of the plurality of areas defined by the orthogonal projection of the support structures 6 on the first substrate 1 may also be along a direction that is not perpendicular to but crosses the first direction or the second direction.

In some embodiments, the reconfigurable antenna further includes a microstrip transmission line L. One end of the microstrip transmission line L is connected to the first metal layer 4, and the other end thereof may be connected to a radio frequency connector (not shown), which may supply, to the reconfigurable antenna, a radio frequency signal and a bias voltage that causes the orientation vectors of the liquid crystal molecules of the liquid crystal layer 3 to be rotated.

The first substrate 1 and the second substrate 2 may be warped due to non-uniform distribution of stress, in consideration of the case where both the first substrate 1 and the second substrate 2 are made of a flexible material. To avoid this problem, in some embodiments, the reconfigurable antenna further includes a first barrier layer 71 and a second barrier layer 72. The first barrier layer 71 is disposed between the first substrate 1 and the first metal layer 4, and the second barrier layer 72 is disposed between the second substrate 2 and the second metal layer 5.

In the present embodiment, each of the first barrier layer 71 and the second barrier layer 72 may be made of an inorganic material. For example, each of the first barrier layer 71 and the second barrier layer 72 may be a single layer of SiO₂ or a double layer of SiO₂/a-Si (i.e., a single layer of SiO₂ and a single layer of a-Si). When each of the first barrier layer 71 and the second barrier layer 72 is the single layer of SiO₂, a thickness of each of first barrier layer 71 and second barrier layer 72 (e.g., a dimension in the stacking direction of the first substrate 1 and the second substrate 2 (i.e., in the vertical direction) in FIG. 1 or 2) may be 2,000 Å to 6,000 Å, and for example, may be 5500 Å. When each of the first barrier layer 71 and the second barrier layer 72 is a double layer of SiO₂/a-Si, the thickness of each of the first barrier layer 71 and the second barrier layer 72 may be 2015 Å to 6015 Å. For example, the thickness of each of the first barrier layer 71 and the second barrier layer 72 may be 6015 Å, in which the single layer of SiO₂ has a thickness of 6,000 Å and the single layer of a-Si has a thickness of 15 Å. Alternatively, the thickness of each of the first barrier layer 71 and the second barrier layer 72 may be 2015 Å, in which the single layer of SiO₂ has a thickness of 2,000 Å and the single layer of a-Si has a thickness of 15 Å. By providing the first barrier layer 71 on the first substrate 1 and providing the second barrier layer 72 on the second substrate 2, stress distribution on the first substrate 1 and the second substrate 2 can be made more uniform, thereby reducing a degree to which each of the first substrate 1 and the second substrate 2 is warped (or twisted). Meanwhile, the first barrier layer 71 and the second barrier layer 72 can prevent the first substrate 1 and the second substrate 2 from being corroded by water and oxygen, and thus a service life of the reconfigurable antenna is lengthened.

In some embodiments, since the first substrate 1 and/or the second substrate 2 are made of a flexible material, a flexible material layer formed each time during formation of the first substrate 1 and/or the second substrate 2 is generally not more than 30 μm. If the first substrate 1 or the second substrate 2 is to be formed with a thickness of 30 μm or more, it is necessary to repeatedly form a plurality of flexible material layers, such that a sum of thicknesses of the plurality of flexible material layers is finally equal to a target thickness. In an embodiment of the present disclosure, each time a flexible material layer has been formed, a third barrier layer (not shown) may be formed on the flexible material layer, and the third barrier layer may be made of an inorganic material. For example, the third barrier layer may be a single layer of SiO₂ or a double layer of SiO₂/a-Si. By providing the third barrier layer(s), the warpage problem of the first substrate 1 and/or the second substrate 2 can be further mitigated, while enhancing the capacity of blocking water and oxygen.

In some embodiments, a material of each of the first metal layer 4 and the second metal layer 5 may include aluminum or copper, such that each of the first metal layer 4 and the second metal layer 5 has a small conductive dielectric loss and a good antenna radiation performance.

In some exemplary embodiments, the thickness of the first substrate 1 (e.g., a dimension in the stacking direction of the first substrate 1 and the second substrate 2 (i.e., in the vertical direction) shown in FIG. 1 or 2) is 90 μm to 110 μm, 45 μm to 55 μm, or 18 μm to 22 μm. A dielectric constant of the first substrate 1 is 4.25 to 5.19. A tangent of a dielectric loss angle of the first substrate 1 is 0.0042 to 0.0052. A thickness (e.g., a dimension in the stacking direction) of each of the first metal layer 4 and the second metal layer 5 is 1.26 μm to 1.54 μm, 0.9 μm to 1.1 μm, 1.08 μm to 1.32 μm, or 7.2 μm to 8.8 μm. It should be noted that the dielectric loss angle may also be referred to as a dielectric phase angle, and is equal to a complementary angle δ of an angle (i.e., a power vector angle Φ) between a current vector and a voltage vector of current flowing in a dielectric under an alternating electric field. Further, the tangent of the dielectric loss angle is a physical quantity that represents a magnitude of a dielectric loss of the dielectric material after an electric field is applied to the dielectric material, and is represented by tan(δ), where δ is the dielectric loss angle.

In some exemplary embodiments, a thickness (e.g., a dimension in the stacking direction) of the liquid crystal layer 3 is 90 μm to 110 μm or 180 μm to 220 μm. A vertical-state dielectric constant of the liquid crystal layer 3 is 2.3 to 2.5, and a tangent of a vertical-state dielectric loss angle is 0.01 to 0.1. A horizontal-state dielectric constant of the liquid crystal layer 3 is 2.9 to 3.1, and a tangent of a horizontal-state dielectric loss angle is 0.001 to 0.1.

In some exemplary embodiments, the radiation patch layer (i.e., the first metal layer 4) has a rectangular shape. A length (e.g., a dimension in the first or second direction in FIGS. 3a-3h) of the radiation patch layer is 23 mm to 28.2 mm, and a width (e.g., a dimension in the second or first direction in FIGS. 3a-3h) of the radiation patch layer is 14 mm to 18 mm In addition, a linewidth of the microstrip transmission line L is 0.39 mm to 0.46 mm or 0.43 mm to 0.53 mm.

The reconfigurable antenna according to an embodiment of the present disclosure is explained in detail below with some examples.

In an example, the thickness (e.g., the dimension in the stacking direction) of the first substrate 1 is 90 μm to 110 μm, e.g., is 100 μm, and the dielectric constant of the first substrate 1 is 4.25 to 5.19, e.g., is 4.72 or 4.7. The tangent of the dielectric loss angle of the first substrate 1 is 0.0042 to 0.0052, e.g., is 0.0047 or 0.005. A thickness, a dielectric constant, and a tangent of a dielectric loss angle of the second substrate 2 may be the same as those of the first substrate 1, respectively. Each of the first metal layer 4 and the second metal layer 5 has the thickness (e.g., the dimension in the stacking direction) of 1.26 μm to 1.54 μm, e.g., of 1.4 μm. The thickness (e.g., the dimension in the stacking direction) of the liquid crystal layer 3 is 90 μm to 110 μm, e.g., is 100 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., is 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004. The length of the radiation patch layer is 23 mm to 28.16 mm, e.g., is 25.6 mm, and the width of the radiation patch layer is 14.4 mm to 17.6 mm, e.g., is 16 mm. The linewidth of the microstrip transmission line L is 0.378 mm to 0.462 mm, e.g., is 0.42 mm.

In the present example, the vertical-state dielectric constant of the liquid crystal layer 3 refers to a dielectric constant of the liquid crystal layer 3 when the long axis direction of the liquid crystal molecules of the liquid crystal layer 3 is parallel to a direction of the applied electric field, and the horizontal-state dielectric constant of the liquid crystal layer 3 refers to a dielectric constant of the liquid crystal layer 3 when the long axis direction of the liquid crystal molecules of the liquid crystal layer 3 is perpendicular to the direction of the applied electric field. The tangent of the vertical-state dielectric loss angle of the liquid crystal layer 3 refers to a tangent of a dielectric loss angle of the liquid crystal layer 3 when the long axis direction of the liquid crystal molecules of the liquid crystal layer 3 is parallel to the direction of the applied electric field, and the tangent of the horizontal-state dielectric loss angle of the liquid crystal layer 3 refers to a tangent of a dielectric loss angle of the liquid crystal layer 3 when the long axis direction of the liquid crystal molecules of the liquid crystal layer 3 is perpendicular to the direction of the applied electric field. In other examples described below, a vertical-state dielectric constant, a horizontal-state dielectric constant, a tangent of a vertical-state dielectric loss angle, and a tangent of a horizontal-state dielectric loss angle of the liquid crystal layer 3 have the same meaning as those in the present example, respectively, and thus will not be explained again below.

In the present example, a resonant frequency f0 of the reconfigurable antenna is continuously adjustable as the dielectric constant of the liquid crystal layer 3 is changed, and an adjustable range of the resonant frequency f0 is 3.38 GHz to 3.76 GHz, i.e., a difference between an upper limit and a lower limit of the adjustable range of the resonant frequency f0 can reach 380 MHz. Further, an S11 curve (which is a curve representing a reflection loss of the reconfigurable antenna and known to one of ordinary skill in the art) at the resonant frequency f0 is smaller than −10 dB, and an impedance bandwidth range of the −10 dB is 50 MHz to 90 MHz. A gain range at a central frequency of 3.5 GHz is −9.79 dBi to −15.9 dBi.

In another example, the thickness (e.g., the dimension in the stacking direction) of the first substrate 1 is 45 μm to 55 μm, e.g., is 50 μm, and the dielectric constant of the first substrate 1 is 4.25 to 5.19, e.g., is 4.72 or 4.7. Further, the tangent of the dielectric loss angle of the first substrate 1 is 0.0042 to 0.0052, e.g., is 0.0047 or 0.005. The thickness (e.g., the dimension in the stacking direction), the dielectric constant, and the tangent of the dielectric loss angle of the second substrate 2 may be the same as those of the first substrate 1. Each of the first metal layer 4 and the second metal layer 5 has a thickness (e.g., a dimension in the stacking direction) of 1.26 μm to 1.54 μm, e.g., of 1.4 μm. The thickness (e.g., the dimension in the stacking direction) of the liquid crystal layer 3 is 90 μm to 110 μm, e.g., is 100 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., is 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004. The length of the radiation patch layer is 23 mm to 28.2 mm, e.g., is 25.6 mm, and the width of the radiation patch layer is 14 mm to 18 mm, e.g., is 16 mm. The microstrip transmission line L has a linewidth of 0.39 mm to 0.46 mm, e.g., of 0.42 mm.

In the present example, the resonant frequency f0 of the reconfigurable antenna is continuously adjustable as the dielectric constant of the liquid crystal layer 3 is changed, and the adjustable range of the resonant frequency f0 is 3.42 GHz to 3.74 GHz, i.e., a difference between an upper limit and a lower limit of the adjustable range of the resonant frequency f0 can reach 320 MHz. Further, the S11 curve at the resonant frequency f0 is smaller than −10 dB, and the impedance bandwidth range of the −10 dB is between 90 MHz and 110 MHz. The gain range at the central frequency of 3.5 GHz is −10.87 dBi to −15.88 dBi.

In another example, the thickness of the first substrate 1 is 90 μm to 110 μm, e.g., is 100 μm. The dielectric constant of the first substrate 1 is 4.248 to 5.192, e.g., 4.72 or 4.7, and the tangent of the dielectric loss angle of the first substrate 1 is 0.0042 to 0.0052, e.g., 0.0047 or 0.005. The thickness, the dielectric constant, and the tangent of the dielectric loss angle of the second substrate 2 may be the same as those of the first substrate 1. Each of the first metal layer 4 and the second metal layer 5 has a thickness of 0.9 μm to 1.1 μm, e.g., of 1 μm. The thickness of the liquid crystal layer 3 is 90 μm to 110 μm, e.g., is 100 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004. The length of the radiation patch layer is 23 mm to 28.2 mm, e.g., is 25.6 mm, and the width of the radiation patch layer is 14 mm to 18 mm, e.g., is 16 mm. The microstrip transmission line L has a linewidth of 0.39 mm to 0.46 mm, e.g., of 0.42 mm.

In the present example, the resonant frequency f0 of the reconfigurable antenna is continuously adjustable as the dielectric constant of the liquid crystal layer 3 is changed, the adjustable range of the resonant frequency f0 is 3.36 GHz to 3.72 GHz, i.e., a difference between an upper limit and a lower limit of the adjustable range of the resonant frequency f0 can reach 360 MHz. The S11 curve at the resonant frequency f0 is smaller than −10 dB, and the impedance bandwidth range of the −10 dB is 60 MHz to 100 MHz. The gain range at the central frequency of 3.5 GHz is −11.53 dBi to −15.41 dBi.

In another example, the thickness of the first substrate 1 is 18 μm to 22 μm, e.g., is 20 μm. The dielectric constant of the first substrate 1 is 4.25 to 5.19, e.g., is 4.72 or 4.7, and the tangent of the dielectric loss angle of the first substrate 1 is 0.0042 to 0.0052, e.g., is 0.0047 or 0.005. The thickness, the dielectric constant, and the tangent of the dielectric loss angle of the second substrate 2 may be the same as those of the first substrate 1. Each of the first metal layer 4 and the second metal layer 5 has a thickness of 1.08 μm to 1.32 μm, e.g., is 1.2 μm. The thickness of the liquid crystal layer 3 is 90 μm to 110 μm, e.g., is 100 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., is 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004. The length of the radiation patch layer is 23 mm to 28.2 mm, e.g., is 25.6 mm, and the width of the radiation patch layer is 14 mm to 18 mm, e.g., is 16 mm. The microstrip transmission line L has a linewidth of 0.43 mm to 0.53 mm, e.g., of 0.48 mm.

In the present example, the resonant frequency f0 of the reconfigurable antenna is continuously adjustable as the dielectric constant of the liquid crystal layer 3 is changed, and the adjustable range of the resonant frequency f0 is 3.34 GHz to 3.76 GHz, i.e., a difference between an upper limit and a lower limit of the adjustable range of the resonant frequency f0 can reach 420 MHz. The S11 curve at the resonant frequency f0 is smaller than −10 dB, and the impedance bandwidth range of the −10 dB is 0 MHz to 60 MHz. The gain range at the central frequency of 3.5 GHz is −9 dBi to −15.6 dBi.

In another example, the thickness of the first substrate 1 is 18 μm to 22 μm, e.g., is 20 μm. The dielectric constant of the first substrate 1 is 4.25 to 5.19, e.g., is 4.72 or 4.7, and the tangent of the dielectric loss angle of the first substrate 1 is 0.0042 to 0.0052, e.g., is 0.0047 or 0.005. The thickness, the dielectric constant, and the tangent of the dielectric loss angle of the second substrate 2 may be the same as those of the first substrate 1. Each of the first metal layer 4 and the second metal layer 5 has a thickness of 7.2 μm to 8.8 μm, e.g., of 8 μm. The thickness of the liquid crystal layer 3 is 90 μm to 110 μm, e.g., is 100 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., is 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004.

The length of the radiation patch layer is 23 mm to 28.2 mm, e.g., is 25.6 mm, and the width of the radiation patch layer is 14 mm to 18 mm, e.g., is 16 mm. The microstrip transmission line L has a linewidth of 0.43 mm to 0.53 mm, e.g., of 0.48 mm.

In the present example, the resonant frequency f0 of the reconfigurable antenna is continuously adjustable along as the dielectric constant of the liquid crystal layer 3 is changed, and the adjustable range of the resonant frequency f0 is 3.34 GHz to 3.74 GHz, i.e., a difference between an upper limit and a lower limit of the adjustable range of the resonant frequency f0 can reach 400 MHz. The S11 curve at the resonant frequency f0 is smaller than −10 dB, and the impedance bandwidth of the −10 dB is 50 MHz to 70 MHz. The gain range at the central frequency of 3.5 GHz is −5.8 dBi to −14.6 dBi.

In another example, the thickness of the first substrate 1 is 18 μm to 22 μm, e.g., is 20 μm. The dielectric constant of the first substrate 1 is 4.25 to 5.19, e.g., is 4.72 or 4.7, and the tangent of the dielectric loss angle of the first substrate 1 is 0.0042 to 0.0052, e.g., is 0.0047 or 0.005. The thickness, the dielectric constant, and the tangent of the dielectric loss angle of the second substrate 2 may be the same as those of the first substrate 1. Each of the first metal layer 4 and the second metal layer 5 has a thickness of 1.08 μm to 1.32 μm, e.g., of 1.2 μm. The thickness of the liquid crystal layer 3 is 180 μm to 220 μm, e.g., is 200 μm. The vertical-state dielectric constant of the liquid crystal layer 3 is 2.3 to 2.5, e.g., is 2.3616 or 2.4, and the tangent of the vertical-state dielectric loss angle of the liquid crystal layer 3 is 0.01 to 0.1, e.g., is 0.0128 or 0.01. The horizontal-state dielectric constant of the liquid crystal layer 3 is 2.9 to 3.1, e.g., is 3.0169 or 3.01, and the tangent of the horizontal-state dielectric loss angle of the liquid crystal layer 3 is 0.001 to 0.1, e.g., is 0.0035 or 0.004. The length of the radiation patch layer is 23 mm to 28.2 mm, e.g., is 25.6 mm, and the width of the radiation patch layer is 14 mm to 18 mm, e.g., is 16 mm. The microstrip transmission line L has a linewidth of 0.43 mm to 0.53 mm, e.g., of 0.48 mm.

In the present example, the resonant frequency f0 of the reconfigurable antenna is continuously adjustable as the dielectric constant of the liquid crystal layer 3 is changed, and the adjustable range of the resonant frequency f0 is 3.30 GHz to 3.74 GHz, i.e., a difference between an upper limit and a lower limit of the adjustable range of the resonant frequency f0 can reach 440 MHz. The S11 curve at the resonant frequency f0 is smaller than −10 dB, and the impedance bandwidth of the −10 dB is 50 MHz to 70 MHz. The gain range at the central frequency of 3.5 GHz is −3 dBi to −10.9 dBi.

In the reconfigurable antenna according to any one of the foregoing embodiments of the present disclosure, the liquid crystal layer 3 is utilized to realize continuous adjustability of the resonant frequency, such that the adjustable function of the reconfigurable antenna can be integrated with the reconfigurable antenna itself, and impedance matching is optimized. As a result, a radio frequency switch and an antenna tuner are omitted to reduce the number of the above components used in a mobile terminal such as a mobile phone, and a radiation efficiency of the reconfigurable antenna is improved.

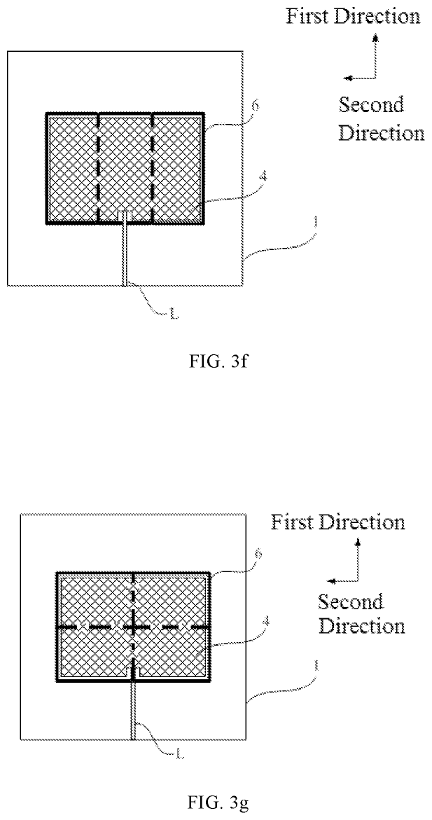

An embodiment of the present disclosure provides a method for manufacturing a reconfigurable antenna, and FIG. 4 is a schematic flowchart showing the method for manufacturing a reconfigurable antenna according to the present embodiment. As shown in FIG. 4, the method may include the following steps S11 to S13.

In step S11, the first metal layer 4 is formed on the first substrate 1.

In step S12, the second metal layer 5 is formed on the second substrate 2.

In steps S11 and S12, the first metal layer 4 and the second metal layer 5 may be formed by depositing a metal such as aluminum or copper in a low temperature environment by a method such as magnetron sputtering, and then performing a patterning process on the deposited metal layer. A stress on each of the first metal layer 4 and the second metal layer 5 deposited in the low temperature environment is small, and the degree to which each of the first substrate 1 and the second substrate 2 is warped can be reduced.

It is noted that the order for performing steps S11 and S12 is not limited. In other words, step S11 may be performed before step S12 or after step S12, or steps S11 and S12 may be performed simultaneously.

In step S13, the first substrate 1 on which the first metal layer 4 is formed and the second substrate 2 on which the second metal layer 5 is formed are aligned with each other and assembled into a cell, and the liquid crystal layer 3 is formed between the first substrate 1 and the second substrate 2. In step S13, the support structure 6 may be formed on the second substrate 2 firstly, and then the first substrate 1 and the second substrate 2 are aligned with each other and assembled into a cell such that the first substrate 1, the second substrate 2 and the support structure 6 form a liquid crystal filling region. Next, the liquid crystal layer 3 is formed between the first substrate 1 and the second substrate 2 by filling liquid crystal therebetween using an instillation method. The manufacturing method will be further described below.

As described above, in the manufacturing method, the first metal layer 4 is formed between the first substrate 1 and the liquid crystal layer 3, and the second metal layer 5 is formed between the second substrate 2 and the liquid crystal layer 3. In this way, the first metal layer 4 may serve as the radiation patch layer of the reconfigurable antenna, and the second metal layer 5 may serve as the ground layer (which includes, e.g., a ground lead and a reflective layer) of the reconfigurable antenna.

In an embodiment of the present disclosure, the reconfigurable antenna may be a frequency reconfigurable antenna. The orthogonal projection of the first metal layer 4 on the first substrate 1 at least partially overlaps the orthogonal projection of the second metal layer 5 on the first substrate 1, and the overlapping area of the orthogonal projections of the first metal layer 4 and the second metal layer 5 on the first substrate 1 covers the orthogonal projection of the liquid crystal layer 3 on the first substrate 1. As such, when different voltages are applied to the first metal layer 4 and the second metal layer 5 (or when a voltage difference is applied across the first metal layer 4 and the second metal layer 5), respectively, the first metal layer 4 and the second metal layer 5 may provide an electric field to the liquid crystal layer 3. The orientation vectors of the liquid crystal molecules of the liquid crystal layer 3 are rotated according to the electric field, and the orientation vectors of the liquid crystal molecules of the liquid crystal layer 3 may be continuously rotated within a certain angle range as the electric field is changed. Since the dielectric constant of the liquid crystal layer 3 depends on the angle at which the orientation vectors of the liquid crystal molecules of the liquid crystal layer 3 are rotated, and the resonant frequency of the reconfigurable antenna depends on the dielectric constant of the liquid crystal layer 3, the resonant frequency of the reconfigurable antenna can be adjusted by controlling the angle at which the orientation vectors of the liquid crystal molecules of the liquid crystal layer 3 are rotated, and the resonant frequency can be continuously adjusted within a certain range, such that the reconfigurability of the resonant frequency of the reconfigurable antenna is achieved.

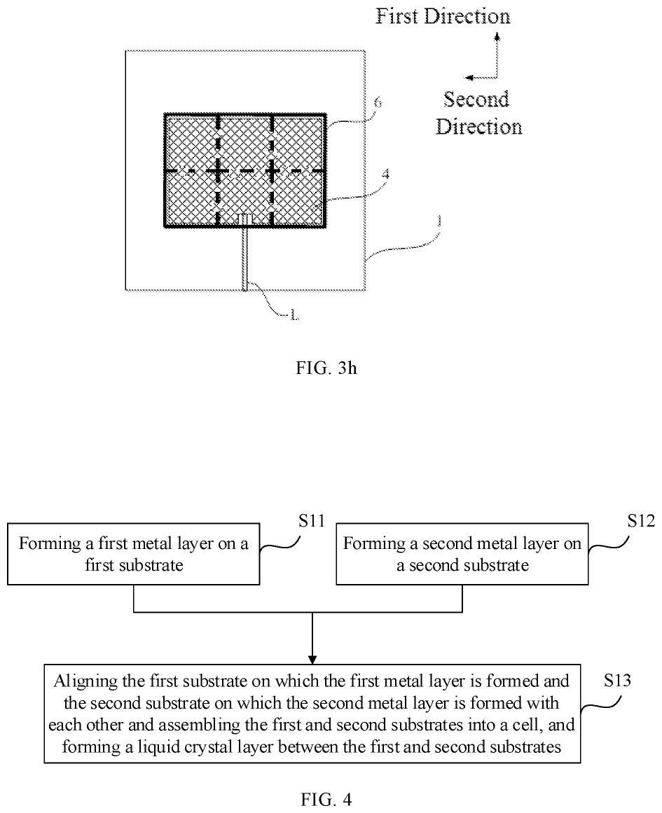

FIG. 5 is a schematic diagram showing structures of a reconfigurable antenna in various steps of another manufacturing method for the reconfigurable antenna according to an embodiment of the present disclosure. The manufacturing method according to the present embodiment will be described in more detail below with reference to FIGS. 4 and 5. In some exemplary embodiments, the first substrate 1 and the second substrate 2 are both flexible substrates. The manufacturing method may include the following steps S21 to S25 and step S3.

In step S21, two high temperature resistant glass substrates (which may also be referred to as base plates) 8 are provided, and a flexible material is coated on the two high temperature resistant glass substrates 8 through a coating process, respectively; further, a high temperature curing process is performed on the coated flexible material, and the first substrate 1 and the second substrate 2 are obtained after a post-cleaning is performed thereon. Optionally, before the flexible material is coated on the two high temperature resistant glass substrates 8, a pre-cleaning process and a drying process may further be performed on the two high temperature resistant glass substrates 8.

In the above processes, a flexible material layer formed by coating the flexible material once and performing the high temperature curing process once is generally not more than 30 μm, and if the first substrate 1 or the second substrate 2 having a thickness of more than 30 μm is to be formed, a plurality of flexible material layers are repeatedly formed to finally result in a target thickness. In an embodiment of the present disclosure, after each flexible material layer is formed by coating the flexible material once and performing the high temperature curing process once, a third barrier layer may be formed on the current (or the currently formed) flexible material layer. The third barrier layer may include an inorganic material, and may be formed by a chemical vapor deposition method. By providing the third barrier layer, the first substrate 1 and/or the second substrate 2 can be further prevented from warping, and meanwhile the blocking effect of water and oxygen is further improved.

In step S22, the first metal layer 4 is formed on the first substrate 1.

In step S23, the second metal layer 5 is formed on the second substrate 2.

In step S24, the support structure 6 is formed on the second substrate 2 provided with the second metal layer 5, such that after the first substrate 1 provided with the first metal layer 4 and the second substrate 2 provided with the second metal layer 5 are aligned with each other and assembled into a cell, the orthogonal projection of the liquid crystal layer 3 on the first substrate 1 and the orthogonal projection of the first metal layer 4 on the first substrate 1 are both located within the area defined by the orthogonal projection of the support structure 6 on the first substrate 1.

In step S24, the support structures 6 may be formed on a surface of the second substrate 2, or on a surface of the second metal layer 5. As an example, in the present embodiment, the support structure 6 is formed on the surface of the second metal layer 5, which is advantageous to simplifying the manufacturing process. After the first substrate 1 provided with the first metal layer 4 and the second substrate 2 provided with both the support structure 6 and the second metal layer 5 are aligned with each other and assembled into a cell, a liquid crystal filling region for filling a liquid crystal material to form the liquid crystal layer 3 therein is defined by the first metal layer 4, the second metal layer 5 and the support structure 6.

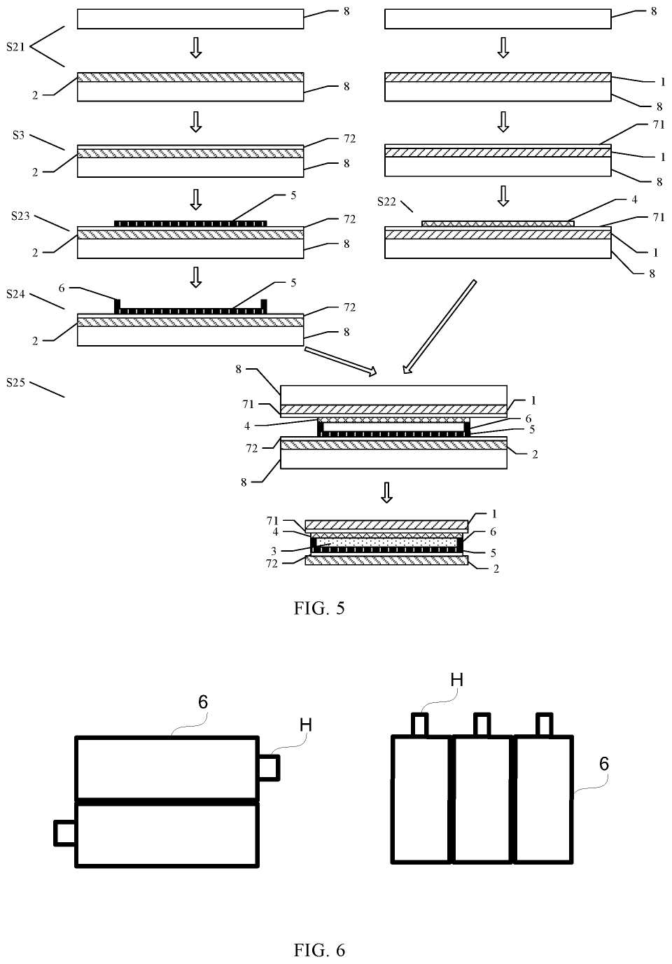

FIG. 6 is a schematic diagram showing the support structure provided with liquid crystal filling openings according to an embodiment of the present disclosure. As shown in FIG. 6, in step S24, a sealant may be coated on the second metal layer 5 in a vacuum environment, and is cured to obtain the support structure 6. For example, the sealant is mixed with spherical spacers each having a diameter of 100 μm (a mass ratio of the spherical spacers to the sealant may be 1:100).

In step S25, the first substrate 1 on which the first metal layer 4 is formed and the second substrate 2 on which the second metal layer 5 is formed are aligned with each other and assembled into a cell, and a liquid crystal filling region is formed between the first substrate 1 and the second substrate 2.

In step S25, liquid crystal may be filled by the instillation method into the liquid crystal filling region formed by the first metal layer 4, the second metal layer 5, and the support structure 6 between the first substrate 1 and the second substrate 2. For this purpose, in step S24, the support structure 6 is formed and the liquid crystal filling openings H are formed in the support structure 6 at the same time, and the liquid crystal filling openings H are in communication with the inside of the support structure 6. In this way, in step S25, the liquid crystal layer 3 is formed inside the support structure 6 by filling the liquid crystal through the liquid crystal filling openings H into the inside (i.e. the liquid crystal filling region described above) of the support structure 6. Then, the step S25 is completed through processes such as leveling, sealing, laser cutting and the like. For example, the liquid crystal may be filled into the liquid crystal filling region in a vacuum environment, thereby ensuring complete de-bubbling of the liquid crystal.

In an embodiment of the present disclosure, each of the liquid crystal filling openings H may have a shape of a rectangle, and may have a length of 5.4 mm to 6.6 mm, e.g., of 6 mm, and a width of 5.4 mm to 6.6 mm, e.g., of 6 mm. For example, as shown in the left portion of FIG. 6, the support structure 6 includes two rectangular support sub-structures and two liquid crystal filling openings H. Each of the liquid crystal filling openings H is in communication with the inside of one of the rectangular support sub-structures, and the two liquid crystal filling openings H are disposed at two opposite sides of the support structure 6, respectively. The liquid crystal can be filled into the support structure 6 having such a configuration through the two liquid crystal filling openings H, thereby improving the uniformity of the thickness (which may also be referred to as a cell gap) of the entire liquid crystal layer 3.

As shown in the right portion of FIG. 6, the support structure 6 includes three hexahedral containers (e.g., rectangular parallelepiped containers or cube containers) and three liquid crystal filling openings H. Each of the three liquid crystal filling openings H is in communication with the inside of one of the three hexahedral containers, and the three liquid crystal filling openings H may be disposed at a same side of the support structure 6. The liquid crystal may be filled into the support structure 6 having such a configuration through the three liquid crystal filling openings H, thereby further improving the uniformity of the thickness of the entire liquid crystal layer 3. For example, the support structure 6 may include a plurality of hexahedral containers and a plurality of liquid crystal filling openings H in one-to-one correspondence with the plurality of hexahedral containers, and an orthogonal projection of each of plurality of hexahedral containers on the first substrate 1 or the second substrate 2 is a rectangle.

After step S25, the glass substrates 8 may be removed by a laser lift-off process, resulting in the reconfigurable antenna.

In some embodiments, the manufacturing method may further include, before steps S22 and S23, the following step S3.

In step S3, the first barrier layer 71 is formed on the first substrate 1, and the second barrier layer 72 is formed on the second substrate 2.

For example, the first metal layer 4 is located on a side of the first barrier layer 71 distal to the first substrate 1, and the second metal layer 5 is located on a side of the second barrier layer 72 distal to the second substrate 2.

In step S3, a layer of SiO₂ (having a thickness of 5500 Å), or a layer of SiO₂ having a thickness of 6,000 Å and a layer of a-Si having a thickness of 15 Å may be deposited on each of the first substrate 1 and the second substrate 2, by using a plasma enhanced chemical vapor deposition method at a temperature of 390° C., thereby obtaining the first barrier layer 71 and the second barrier layer 72.

In other some embodiments, when the first metal layer 4 and the second metal layer 5 are formed, a flexible printed circuit (FPC) manufacturing process may alternatively be adopted to attach patterned metal materials on the first substrate 1 and the second substrate 2, respectively, so as to form the first metal layer 4 and the second metal layer 5. This manufacturing process is simple and is beneficial to reducing the cost thereof.

In other some embodiments, each of the first substrate 1 and the second substrate 2 may alternatively be made of polyethylene terephthalate (PET). When the first metal layer 4 and the second metal layer 5 are formed, a groove for forming the liquid crystal layer 3 may be etched in each of the first substrate 1 and the second substrate 2 through an etching process, and then a metal material is electroplated on an inner wall of the groove to obtain the first metal layer 4 and the second metal layer 5. This manufacturing process is simpler and is beneficial to reducing the cost thereof.

It should be understood that, the manufacturing method may further include steps of forming other components of the reconfigurable antenna as shown in FIGS. 1-3h, in addition to the above-described steps S11-S13, steps S21-S25 and step S3.

It is to be understood that the foregoing embodiments of the present disclosure may be combined with each other in a case of no explicit conflict.

It should be understood that the foregoing embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

What is claimed is:

1. A reconfigurable antenna, comprising:
a first substrate and a second substrate opposite to each other;
a liquid crystal layer between the first substrate and the second substrate;
a first metal layer between the first substrate and the liquid crystal layer, wherein the first metal layer serves as a radiation patch layer of the reconfigurable antenna; and
a second metal layer between the second substrate and the liquid crystal layer, wherein the second metal layer serves as a ground layer of the reconfigurable antenna;
wherein the first metal layer and the second metal layer are configured to provide an electric field to the liquid crystal layer, so as to rotate orientation vectors of liquid crystal molecules of the liquid crystal layer.

2. The reconfigurable antenna according to claim 1, further comprising a support structure, wherein the support structure is between the first substrate and the second substrate, an orthogonal projection of the liquid crystal layer on the first substrate and an orthogonal projection of the first metal layer on the first substrate are both within an area defined by an orthogonal projection of the support structure on the first substrate.

3. The reconfigurable antenna according to claim 2, wherein the orthogonal projection of the support structure on the first substrate defines a plurality of areas, which are not in communication with each other.

4. The reconfigurable antenna according to claim 2, wherein the orthogonal projection of the support structure on the first substrate defines a plurality of areas, at least adjacent two of which are in communication with each other.

5. The reconfigurable antenna according to claim 1, further comprising a microstrip transmission line, wherein one end of the microstrip transmission line is connected to the first metal layer.

6. The reconfigurable antenna according to claim 1, further comprising a first barrier layer and a second barrier layer, wherein the first barrier layer is between the first substrate and the first metal layer, and the second barrier layer is between the second substrate and the second metal layer.

7. The reconfigurable antenna according to claim 1, wherein each of the first substrate and the second substrate is a flexible substrate.

8. The reconfigurable antenna according to claim 1, wherein each of the first substrate and the second substrate has a thickness of 90 μm to 110 μm, 45 μm to 55 μm, or 18 μm to 22 μm, a dielectric constant of 4.25 to 5.19, and a tangent of a dielectric loss angle of 0.0042 to 0.0052.

9. The reconfigurable antenna according to claim 1, wherein a thickness of each of the first metal layer and the second metal layer is 1.26 μm to 1.54 μm, 0.9 μm to 1.1 μm, 1.08 μm to 1.32 μm, or 7.2 μm to 8.8 μm.

10. The reconfigurable antenna according to claim 1, wherein
the liquid crystal layer is has a thickness of 90 μm to 110 μm or 180 μm to 220 μm;
the liquid crystal layer has a vertical-state dielectric constant of 2.3 to 2.5, and a tangent of a vertical-state dielectric loss angle of 0.01 to 0.1; and
the liquid crystal layer has a horizontal-state dielectric constant of 2.9 to 3.1, and a tangent of a horizontal-state dielectric loss angle of 0.001 to 0.1.

11. The reconfigurable antenna according to claim 5, wherein
the radiation patch layer has a shape of a rectangle, a length of 23 mm to 28.2 mm, and a width of 14 mm to 18 mm; and
the microstrip transmission line has a linewidth of 0.39 mm to 0.46 mm or 0.43 mm to 0.53 mm.

12. The reconfigurable antenna according to claim 7, wherein each of the first substrate and the second substrate comprises a flexible organic material, which comprises polyimide, polycarbonate, polyacrylate, polyetherimide, polyethersulfone, polyethylene terephthalate, or polyethylene naphthalate.

13. The reconfigurable antenna according to claim 3, wherein the plurality of areas have a same shape of a rectangle, and are arranged in a preset direction.

14. The reconfigurable antenna according to claim 3, wherein the plurality of areas have a same shape of a rectangle, and are arranged in an array comprising a plurality of rows and a plurality of columns.

15. The reconfigurable antenna according to claim 4, wherein the plurality of areas have a same shape of a rectangle, and are arranged in a preset direction.

16. The reconfigurable antenna according to claim 4, wherein the plurality of areas have a same shape of a rectangle, and are arranged in an array comprising a plurality of rows and a plurality of columns.

17. The reconfigurable antenna according to claim 6, wherein each of the first barrier layer and the second barrier layer comprises an inorganic material.

18. The reconfigurable antenna according to claim 17, wherein each of the first barrier layer and the second barrier layer comprises a single layer of SiO₂, or a double layer comprising a single layer of SiO₂ and a single layer of a-Si.

19. The reconfigurable antenna according to claim 18, wherein the single layer of SiO₂ has a thickness between 2,000 Å and 6,000 Å, and the single layer of a-Si has a thickness of 15 Å.

20. A method for manufacturing a reconfigurable antenna, comprising:
forming a first metal layer on a first substrate;
forming a second metal layer on a second substrate;
aligning the first substrate on which the first metal layer is formed and the second substrate on which the second metal layer is formed with each other and assembling the first substrate and the second substrate into a cell, and forming a liquid crystal layer between the first substrate and the second substrate;
wherein the first metal layer is located between the first substrate and the liquid crystal layer, the second metal layer is located between the second substrate and the liquid crystal layer, the first metal layer serves as a radiation patch layer of the reconfigurable antenna, and the second metal layer serves as a ground layer of the reconfigurable antenna.
